(19) United States
(12) Patent Application Publication
(10) Pub. No.: US 2018/0093366 A1
(43) Pub. Date: Apr. 5, 2018

(54) WRENCH WITH TWO DRIVING GEARS

(71) Applicant: Shwu-Ruu Chern, Taichung (TW)

(72) Inventor: Shwu-Ruu Chern, Taichung (TW)

(21) Appl. No.: 15/283,416

(22) Filed: Oct. 2, 2016

(51) Int. Cl. B25B 13/48; B25B 17/00; B25B 23/00

(52) U.S. Cl. CPC B25B 13/481; B25B 23/0007; B25B 17/00

(57) ABSTRACT

A wrench includes a head which has a first room and a second room defined therein. The first room communicates with the second room. Two holes are defined through the bottom of the head and respectively communicates with the first and second rooms. A first driving gear and a second driving gear are respectively located in the first room and the second room, and are engaged with each other. Each of the first driving gear and the second driving gear has an operation portion and a protrusion extending from two ends thereof. The user uses another wrench to drive the operation portion of the first gear which drives the operation portion of the second driving gear to tighten or loosen the object connected to the operation portion of the second gear.

### BACKGROUND OF THE INVENTION

### 1. Fields of the Invention

The present invention relates to a hand tool, and more particularly, to a wrench having two driving gears which are engaged with each other so that the user rotates one gear to drive the other gear.

### 2. Descriptions of Related Art

The conventional wrenches such as ratchet wrenches generally includes a driving gear received in the head of the wrench, and a ratchet mechanism is located in the head. The ratchet mechanism includes a pawl which is removably engaged with the driving gear such that the user can rotate the wrench back and forth without disengaging the wrench from the object. However, when the conventional ratchet wrench is used in a narrow space, the narrow space limits the angle of rotation of the handle, so that the ratchet wrench cannot be rotated back and forth as desired.

The present invention intends to provide a wrench which includes two driving gears which are engaged with each other, and each driving gear is connected with a socket, so that the user uses another hand tool to rotate one socket, the other sock is driven to tighten or loosen the object.

### SUMMARY OF THE INVENTION

The present invention relates to a wrench and comprises a handle and a head connected to one end of the handle. The head has a first room and a second room defined therein. The first room communicates with the second room. Two holes are defined through the bottom of the head and respectively communicate with the first and second rooms.

A first driving gear is located in the first room and has a first operation portion extending from the top thereof. A first protrusion extends from the underside of the first driving gear and extends through the hole corresponding to the first room. A second driving gear is located in the second room and has a second operation portion extending from the underside thereof. A second protrusion extends from the top of the second driving gear. The second operation portion extends through the hole corresponding to the second room. The first driving gear is engaged with the second driving gear. A cover is connected to the top of the head and has a first aperture and a second aperture, wherein the first operation portion extends through the first aperture, and the second protrusion extends the second hole.

Preferably, the first operation portion is a rectangular rod.

Preferably, the second operation portion is a rectangular rod.

Preferably, the number of teeth of the first driving gear is more than that of the second driving gear.

The primary object of the present invention is to provide a wrench which is suitable for being used in a narrow space.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the wrench of the present invention;

FIG. 2 is a perspective view to show the wrench of the present invention;

FIG. 3 is another perspective view to show the wrench of the present invention;

FIG. 4 is a perspective view to show the wrench of the present invention, wherein the cover is not yet connected to the head of the wrench;

FIG. 5 is a top view of the head of the wrench of the present invention, wherein the cover is not yet connected, and

FIGS. 6-8 show the operation of the wrench of the present invention.

### DETAILED DESCRIPTION OF THE PREFERRED EMBODIMENT

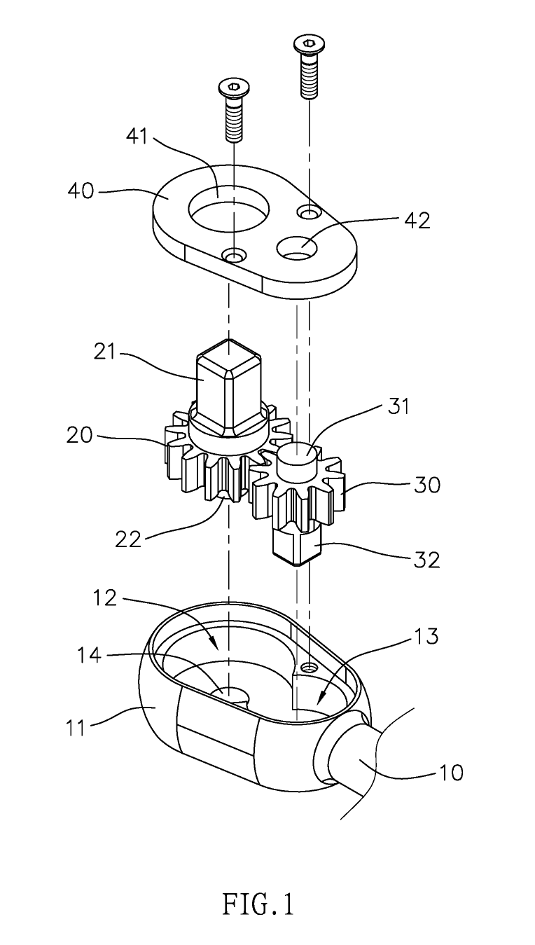

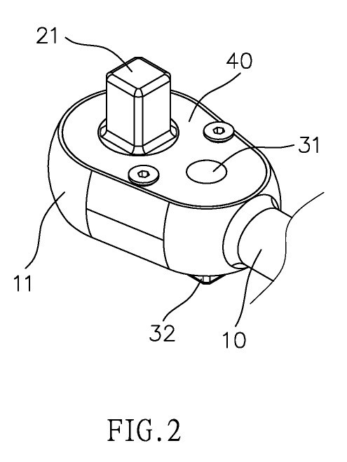

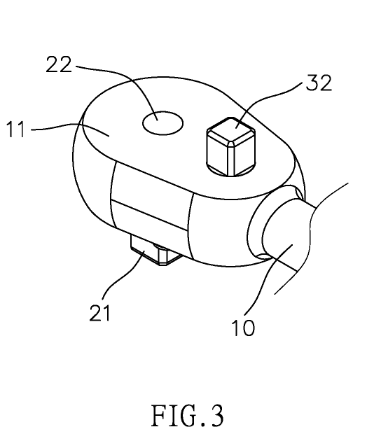

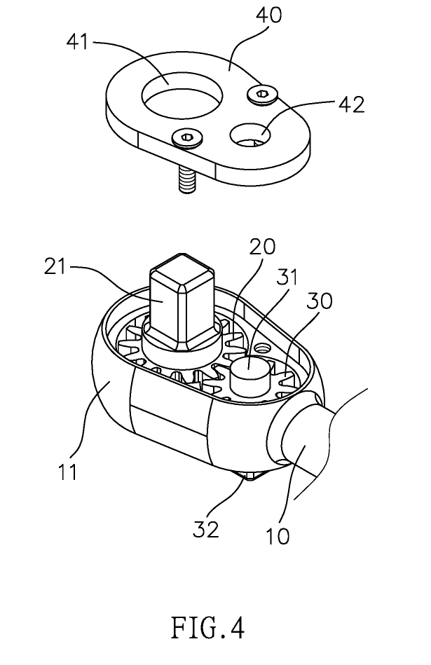

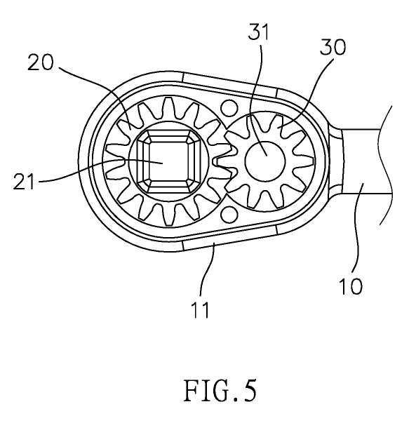

Referring to FIGS. 1 to 6, the wrench of the present invention comprises a handle 10 and a head 11 is connected to one end of the handle 10. The head 11 has a first room 12 and a second room 13 defined therein, wherein the first room 12 communicates with the second room 13. Two holes 14 are defined through the bottom of the head 11 and respectively communicate with the first and second rooms 12, 13. A first driving gear 20 is located in the first room 12 and has a first operation portion 21 extending from the top thereof, and a first protrusion 22 extends from the underside of the first driving gear 20 and extends through the hole 14 corresponding to the first room 12.

A second driving gear 30 is located in the second room 13 and has a second operation portion 32 extending from the underside thereof. A second protrusion 31 extends from the top of the second driving gear 30, and the second operation portion 32 extends through the hole 14 corresponding to the second room 13. The first driving gear 20 is engaged with the second driving gear 30. In this embodiment, the first operation portion 21 is a rectangular rod, and the second operation portion 32 is a rectangular rod as well. The number of the teeth of the first driving gear 20 is more than that of the second driving gear 30.

A cover 40 is connected to the top of the head 11 and has a first aperture 41 and a second aperture 42. The first operation portion 21 extends through the first aperture 41, and the second protrusion 31 extends the second hole 42.

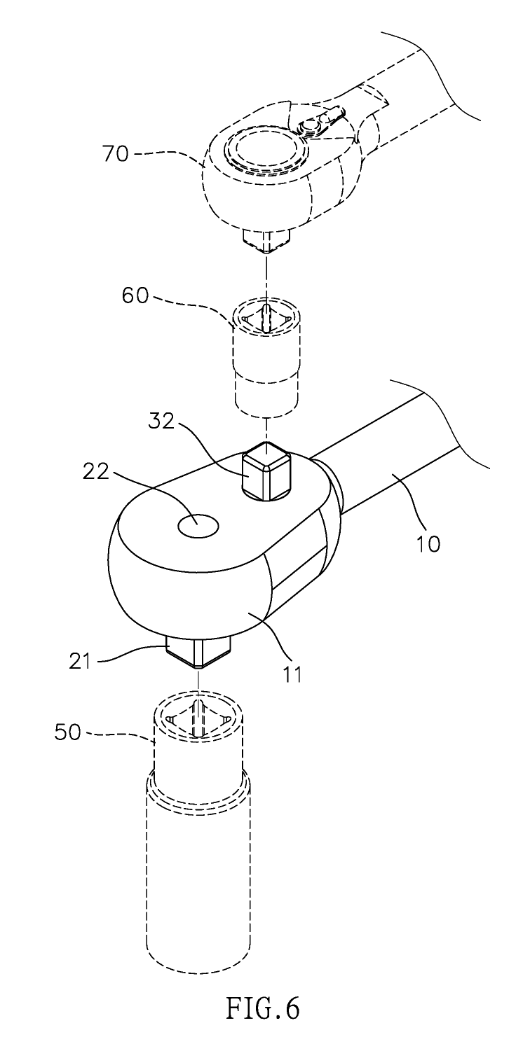

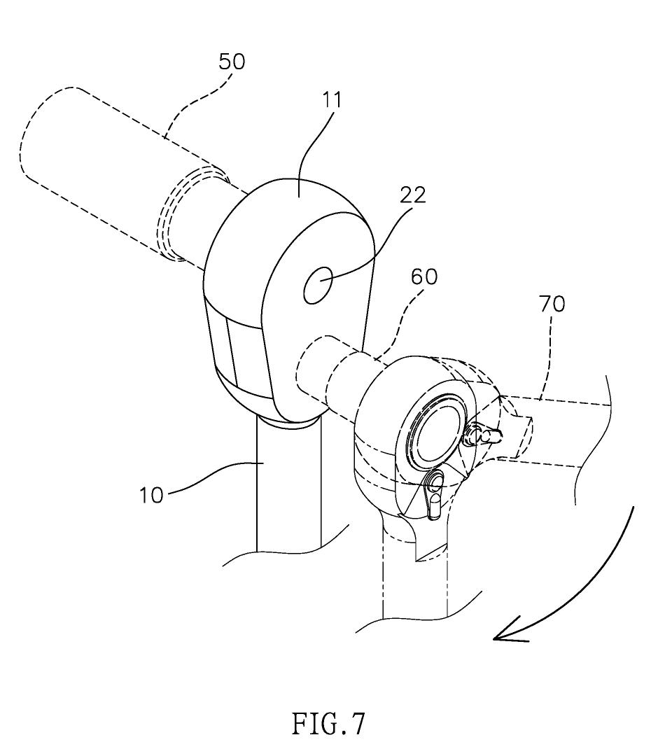

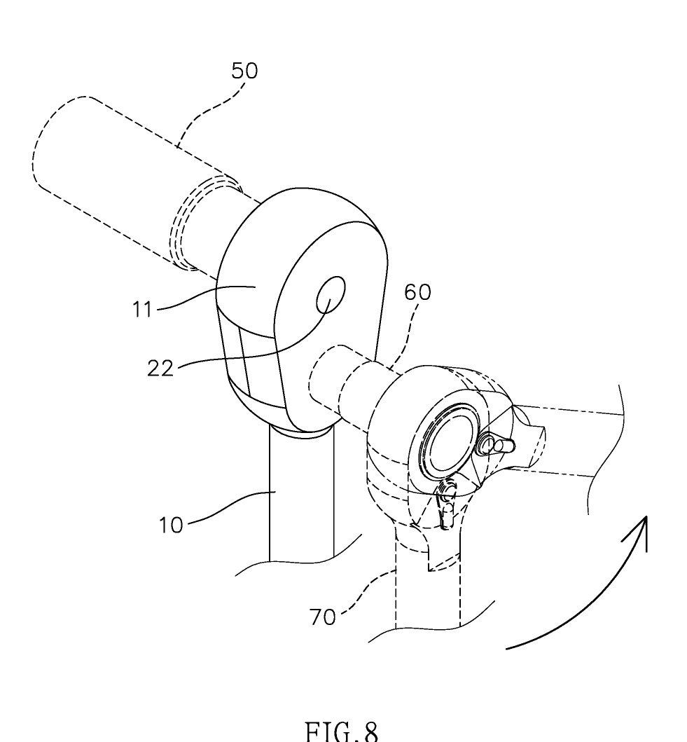

As shown in FIGS. 6 to 8, two respective sockets 50, 60 are respectively connected to the first operation portion 21 and the second operation portion 32. Another wrench is used to be connected to the socket 60. The socket 50 is connected to the object to be tightened or loosened. The user operates the wrench 70 to rotate the socket 60 which rotates the second driving gear 30, and the second driving gear 30 drives the first driving gear 20, so that the socket 50 is rotated to tighten or loosened the object, while the handle 10 is not needed to rotated in the narrow space.

Because the first driving gear 20 has more teeth than the second driving gear 30, so that when the second driving gear 30 is rotated, the first driving gear 20 is rotated at higher speed to quickly tighten or loosened the object.

While we have shown and described the embodiment in accordance with the present invention, it should be clear to those skilled in the art that further embodiments may be made without departing from the scope of the present invention.

What is claimed is:

1. A wrench comprising:
a handle and a head connected to an end of the handle, the head having a first room and a second room defined therein, the first room communicating with the second room, two holes defined through a bottom of the head and respectively communicating with the first and second rooms;
a first driving gear located in the first room and having a first operation portion extending from a top thereof, a first protrusion extending from an underside of the first driving gear and extending through the hole corresponding to the first room;
a second driving gear located in the second room and having a second operation portion extending from an underside thereof, a second protrusion extending from a top of the second driving gear, the second operation portion extending through the hole corresponding to the second room, the first driving gear engaged with the second driving gear, and
a cover connected to a top of the head and having a first aperture and a second aperture, the first operation portion extending through the first aperture, the second protrusion extending the second hole.

2. The wrench as claimed in claim 1, wherein the first operation portion is a rectangular rod.

3. The wrench as claimed in claim 1, wherein the second operation portion is a rectangular rod.

4. The wrench as claimed in claim 1, wherein a number of teeth of the first driving gear is more than that of the second driving gear.
